(19) United States
(12) Patent Application Publication
(10) Pub. No.: US 2012/0100239 A1
(43) Pub. Date: Apr. 26, 2012

(54) SWITCHING WARE

(75) Inventors: Jian-ming Li, Tu Cheng (TW); Xiao-ping Wu, Tu Cheng (TW); Shih-hsiung Ho, Tu Cheng (TW)

(73) Assignee: Cheng Uei Precision Industry Co., LTD., Tu Cheng City (TW)

(21) Appl. No.: 12/909,735

(22) Filed: Oct. 21, 2010

(51) Int. Cl. B29C 33/20

(52) U.S. Cl. 425/161

(57) ABSTRACT

Disclosed is a switching ware, employed in a mold having a cope plate, a middle template and a lower die. The switching ware comprises a trip lever, a trip limit element and at least one spring. The trip lever is installed on the cope plate. A trip limit controller is fixedly installed on the lower die and has a clipping plate formed in the middle of the trip lever. The trip limit element is slidably installed inside the open slot. The trip limit element can extend out of the open slot to reach against the clipping plate and the trip limit controller can push the trip limit element to slide in the open slot. The mold can complete the operation of closing mold in a specific sequence with the switching ware of the present invention. The structure of the switching ware is simple, safe, reliable and with low failure probability.

### BACKGROUND OF THE INVENTION

1. Field of the Invention

The present invention generally relates to a molding, and more particularly, to a switching ware of a mold needed to be closed in a specific sequence.

2. Description of Prior Art

Generally, the injection mold with double parting surfaces or with multiple parting surfaces needs to close mold in a specific sequence with a certain mechanism for completing the operation of closing mold. Generally, such mechanism is so called switching ware.

In China patent No. 200720127538.4, a switching ware is disclosed. The switching ware comprises a main body, a compression lock pin, a slide block, a movable pin and a base plate. The main body is locked with the outer wall of the fixed half. The main body also comprises a first pin slot, a second pin slot and a block slot. One end of the compression lock pin penetrates through the interior of the first pin slot of the main body. The other end of the compression lock pin is locked with the outer wall of the moving half. Meanwhile, a first compression lock slot is formed at the bottom surface of the compression lock pin in accordance with the first pin slot. The slide block is assembled in the interior of the block slot of the main body. A reentrant for receiving one end of an elastic component is formed at the bottom surface of the slide block. A third pin slot is formed at the slide block in accordance with the second pin slot and a guide surface is formed on the slant side of the bottom surface of the third pin slot. One end of the movable pin penetrates through the interior of the second pin slot. The other end of the movable pin is locked with the outer wall of a supporting plate. Meanwhile, a second compression lock slot is formed at the bottom surface of the movable pin in accordance with the third pin slot of the slide block. A guide surface is formed on the inner slant side of the second compression lock slot. The base plate is locked at the bottom of the main body and the upper end surface thereof is provided for the other end of the elastic component to reach against.

However, the structure of the aforesaid switching ware is complicated and function failure of the structure easily occurs with too many components.

### SUMMARY OF THE INVENTION

For solving the drawbacks of aforementioned prior art, an objective of the present invention is to provide a switching ware simply structured, safe, reliable and with low failure probability.

For realizing the aforesaid objective, the switching ware of the present invention is employed in a mold having a cope plate, a middle template and a lower die. The switching ware comprises a trip lever, a trip limit element and at least one spring. The trip lever is installed on the cope plate and has a clipping plate formed in the middle of the trip lever. A trip limit controller is fixedly installed on the lower die and has a first sliding cant formed on the trip limit controller. The trip limit element is slidably installed inside the open slot and a second sliding cant is formed on the trip limit element. The trip limit element can extend out of the open slot to reach against the clipping plate and the trip limit controller can push the trip limit element to slide in the open slot.

As aforementioned, the mold can complete the operation of closing mold in a specific sequence with the switching ware of the present invention The structure of the switching ware is simple, safe, reliable and with low failure probability.

### BRIEF DESCRIPTION OF THE DRAWINGS

FIG. 1 shows a side view diagram of a mold with a switching ware according to the present invention.

FIG. 2 shows a sectional side view diagram of the mold with the switching ware before the mold is closed.

FIG. 3 shows a sectional side view diagram of the mold with the switching ware after the mold is closed.

FIG. 4 shows an exploded assembly diagram of the switching ware of the present invention.

FIG. 5 shows a three dimensional view diagram of the trip limit element shown in FIG. 4.

FIG. 6 shows a three dimensional view diagram of the trip lever shown in FIG. 4.

### DETAILED DESCRIPTION OF THE INVENTION

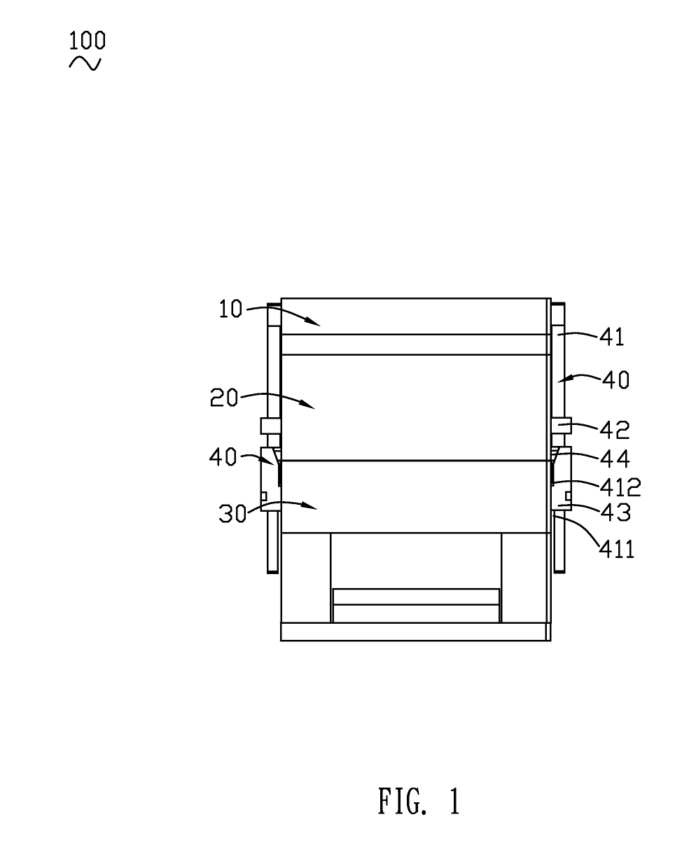

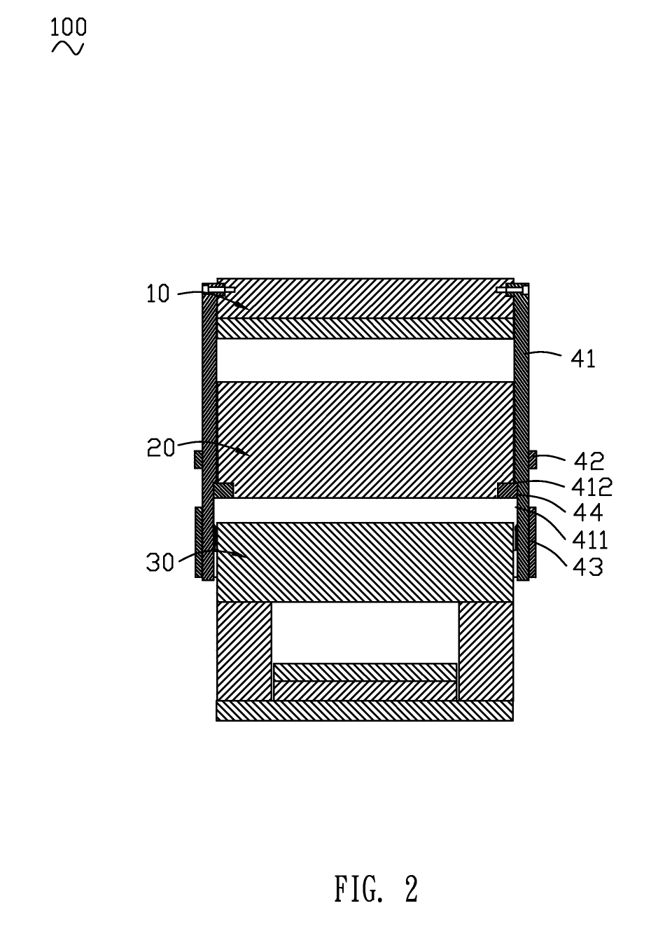

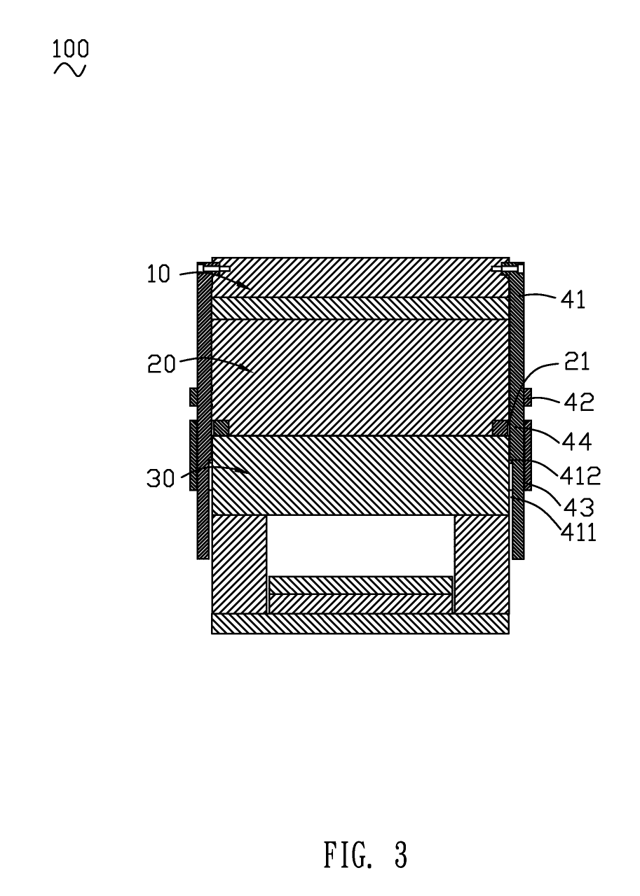

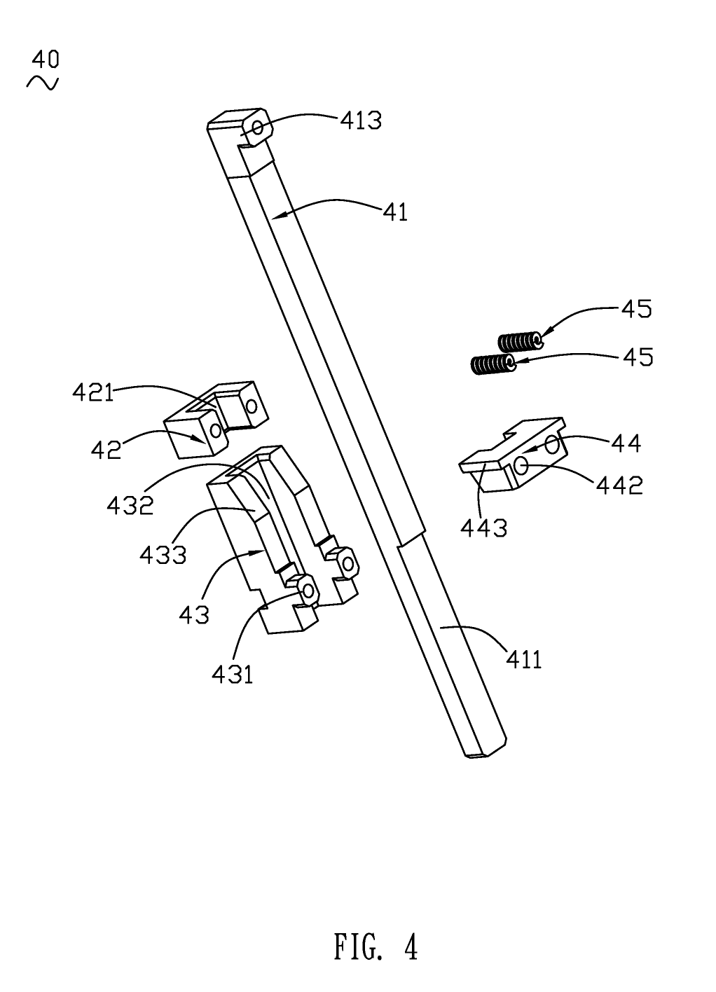

Please refer to FIG. 1, FIG. 2, FIG. 3 and FIG. 4. The switching ware 40 of the present invention is employed a mold 100 needed to be closed in a specific sequence. The mold 100 has a cope plate 10, a middle template 20 and a lower die 30. An open slot 21 is opened on one side of the middle template 20. Two guide slots (not shown) are respectively formed at two sides of the open slot 21.

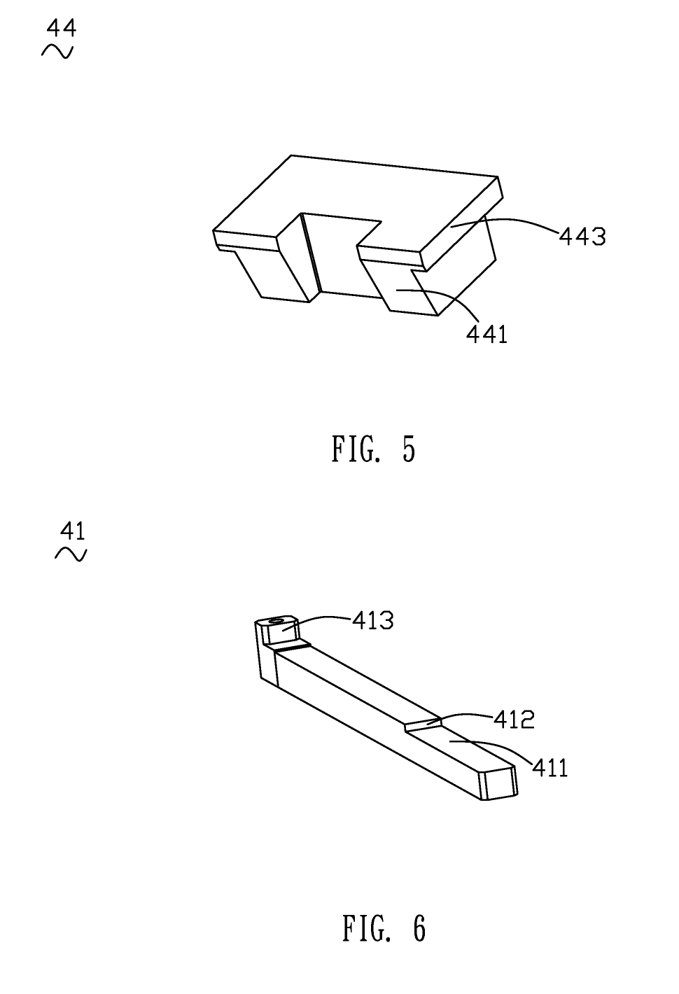

Please refer to FIG. 4 still and refer further to FIG. 5 and FIG. 6. Two switching wares 40 are installed at two sides of the mold 100. The switching ware 40 comprises a rod-like trip lever 41, a middle template limiter 42, a trip limit controller 43 and a trip limit element 44. A groove 411 is formed at the upper end in the middle of the trip lever 41 so as to form a clipping plate 412. A bump 413 extrudes from the top end of the trip lever 41. The trip lever 41 is installed on the cope plate 10 through the bump 413. The middle template limiter 42 is fixedly installed on the middle template 20. The middle template limiter 42 comprises a restrict slot 421 to allow the trip lever 41 movably passing through the restrict slot 421. Accordingly, the trip lever 41 can be protected thereby. Two fixed blocks 431 extrudes from the trip limit controller 43. The trip limit controller 43 is fixed with the lower die 30 by the two fixed blocks 431. The trip limit controller 43 comprises a slide slot 432 penetrating therethrough up and down. A first sliding cant 433 is formed on the trip limit controller 43. The trip lever 41 can movably pass through the slide slot 432 of the trip limit controller 43 up and down.

In the present invention, the trip limit element 44 is slidably installed inside the open slot 21 of the middle template 20. The trip limit element 44 can extend out of the open slot 21 to reach against the clipping plate 412. A second sliding cant 441 is formed on the trip limit element 44. By moving the first sliding cant 433 along the second sliding cant 441, the trip limit controller 43 can push the trip limit element 44 to slide in the open slot 21. Two accepting spaces 442 are formed at the beck end of two sides of the trip limit element 44. The two sides of the trip limit element 44 extrude out to form guide plates 443. The guide plates 443 slide inside the open slots 21 along the aforesaid guide slots. Springs 45 are installed between the middle template 20 and the trip limit element 44. One ends of the springs 45 are accepted inside the accepting spaces 442 and the other ends of the springs 45 reach against slot walls of one end of the open slot 21 to move the trip limit element 44.

Please refer to FIG. 2 and FIG. 3. Before the mold 100 employing the switching ware 40 of the present invention is closed, the clipping plate 412 of the trip lever 41 reaches against the top wall of the trip limit element 44. Accordingly, a certain distance between the cope plate 10 and the middle template 20 can be guaranteed. At this time, the cope plate 10 and the middle template 20 can be moved downward together to put the middle template 20 and the lower die 30 in place for closing mold. After the middle template 20 and the lower die 30 are in place and closed, the trip limit controller 43 can push the trip limit element 44 and compress the springs 45 to slide toward the inside of the open slot 21 by moving the first sliding cant 433 along the second sliding cant 441. Accordingly, the clipping plate 412 of the trip lever 41 is slipped off from the top wall of the trip limit element 44. Then, the cope plate 10 and the middle template 20 are put in place and closed. Consequently, the mold 100 employing the switching ware 40 of the present invention can guarantee to reliably support the cope plate 10 before the lower die 30 and the middle template 20 are put in place and closed. After the middle template 20 and the lower die 30 are in place and closed completely, the cope plate 10 and the middle template 20 start to be put in place and closed to ensure the specific sequence for closing mold precisely. The molds will not be damaged.

As aforementioned, the mold 100 can complete the operation of closing mold in a specific sequence with the switching ware 40 of the present invention. The structure of the switching ware 40 is simple, safe, reliable and with low failure probability.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A switching ware, employed in a mold having a cope plate, a middle template and a lower die wherein the mold needs to be closed in a specific sequence and an open slot is opened on the middle template, comprising:
a trip lever, installed on the cope plate, and having a clipping plate formed in the middle of the trip lever, and a trip limit controller is fixedly installed on the lower die and has a first sliding cant formed on the trip limit controller;
a trip limit element, slidably installed inside the open slot and a second sliding cant is formed on the trip limit element; and
at least one spring, installed between the middle template and the trip limit element, wherein the trip limit element can extend out of the open slot to reach against the clipping plate and the trip limit controller can push the trip limit element to slide in the open slot by moving the first sliding cant along the second sliding cant.

2. The switching ware of claim 1, wherein a middle template limiter is fixedly installed on the middle template and the middle template limiter comprises a restrict slot to allow the trip lever movably passing through the restrict slot.

3. The switching ware of claim 1, wherein the trip limit controller comprises a slide slot penetrating through for the trip lever to movably pass through the slide slot of the trip limit controller up and down.

4. The switching ware of claim 1, wherein two accepting spaces are formed at the beck end of two sides of the trip limit element, one ends of the springs are accepted inside the accepting spaces and the other ends of the springs reach against slot walls of one end of the open slot.
